(19) United States
(12) Patent Application Publication
(10) Pub. No.: US 2019/0298487 A1
(43) Pub. Date: Oct. 3, 2019

(54) Dental Unit Flush Adaptor

(71) Applicant: Robert Shawn Mackey, Flushing, MI (US)

(72) Inventor: Robert Shawn Mackey, Flushing, MI (US)

(21) Appl. No.: 16/235,962

(22) Filed: Dec. 28, 2018

(51) Int. Cl. A61C 1/00; A61C 1/08

(52) U.S. Cl. CPC A61C 1/0076; A61C 1/08

(57) ABSTRACT

claim with this invention, [01] Provide a more efficient process to flush the water lines, [02] Water lines can all be flushed at the same time more effectively, [03] Provide drastic increase of pressure from flushing without my device, [04] Cuts down on bio-film growth, [05] Bio-film growth is one of the major problems in the dental equipment industry, [06] My device since it is connected to the suction will help evacuate growing bio-film cultures, [07] Increases the water pressure while flushing the water lines, [08] Provides dental offices with a tool to clear out clogs in their tubings cutting down on money spent for service calls.

### BACKGROUND OF THE INVENTION

The “Dental Unit Flush Adaptor” was an idea that I came up with while running a dental equipment repair business in Florida. After eight years and thousands of service calls in dental offices both in Florida and now in Michigan, I began to realize that one of the single biggest problems that all dental office staff deals with is maintaining the water lines in all of the equipment used to treat patients. The problem of “bio-film” growth in the dental industry has been an issue that has been dealt with using water filters, special “bio-free” tubing and tablets that can be put into the water bottles that feed these dental units when they are not connected to city water. These have all been proven effective but the problem that is still not solved is the proper “flushing” of the water lines in all the equipment that is used to treat patients within the dental operatory. All major manufacturers of dental delivery units have a “flush valve” built into the delivery unit. The biggest problem with the “flush valve” that is built into the delivery unit is that most office staff and dental assistants do not utilize this feature to flush the lines properly and they find this procedure to be bothersome. I wanted to design a device that would be more effective at reducing the bio-film and would be easier for office staff to use on a regular basis.

### BRIEF SUMMARY OF THE INVENTION

The “Dental Unit Flush Adaptor” was designed to simplify the process of flushing the water lines on all dental units. Most major brand manufactured dental units contain a water flush button/toggle valve that will activate the water flush that basically pushes old water out of the hand piece tubing in the delivery unit and replaces this area of the tubing with fresh water. The biggest two problems that I have seen in all the years of doing this service work is that this flush button/toggle valve is hardly ever used the way the dental equipment manufacturers intended, and the water flush itself is under minimal pressure. My adapter would allow all of the hand piece tubings on the dental unit to be flushed at once, along with the water lines going to the air/water syringes. The tubing being flushed connects to the adaptor I designed and this adaptor is connected to the vacuum/suction line on the bottom of the adaptor. This allows the water to be flushed through the system under much higher pressure, which performs a more thorough flushing and allows all the lines to be flushed at once. This adaptor will also make this process for all office staff, including dental assistants and hygienists to perform the proper water line maintenance in the rooms they are working out of. The other major advantage to my invention, by incorporating the vacuum line into this process, it can also evacuate all the water from the hand piece tubings which will prevent the bio-film growth to even begin. This is a big advantage for offices that don't use certain hand piece tubings regularly.

### BRIEF DESCRIPTION OF DRAWINGS

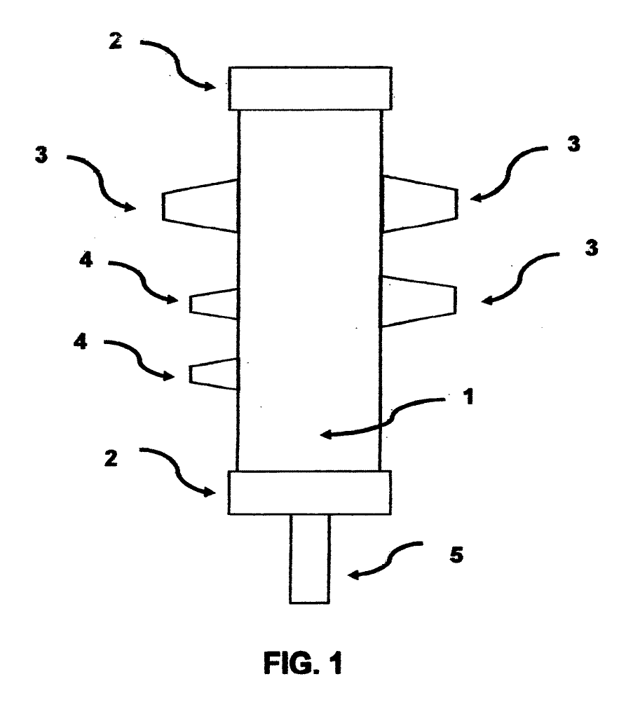

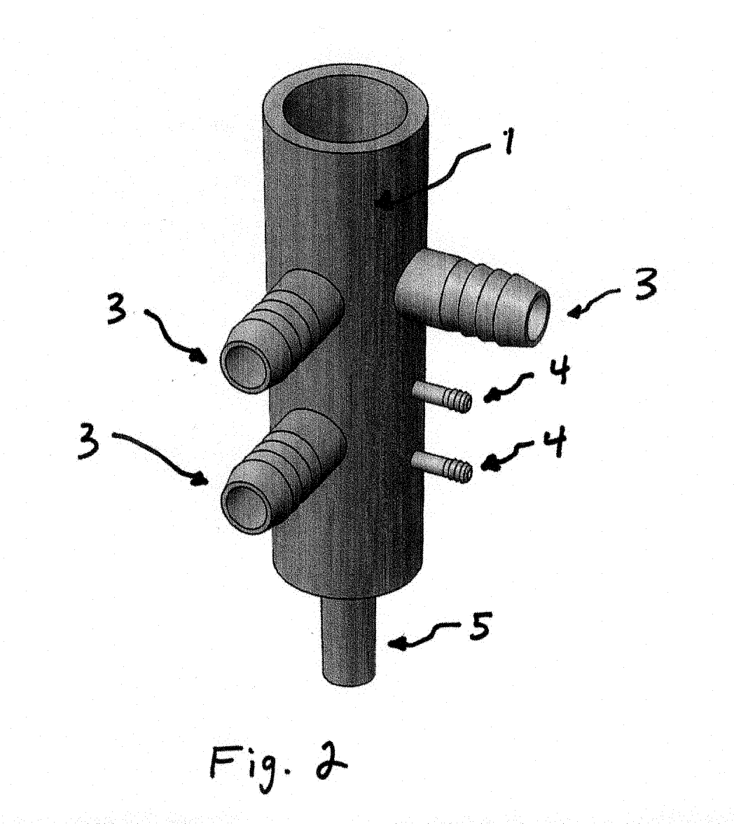

In FIG. 1, is a front view of the device. The device itself is just a hollow tube designed to be a manifold. My prototype was designed with a 4 inch section of 1½ inch PVC pipe (1). Attached to this PVC pipe are 2 PVC caps at opposite ends (2). Also attached to the pipe itself are 5 hose barbs. There are 3½ inch hose barbs (3), and 2⅛ inch hose barbs (4). The bottom of the pipe is a 7/16 OD inch tube, (5) which is 2 inches in length. The bottom tube (5), will be connected to the vacuum line in the dental operatory. When the device is in use, there will be vinyl tubings of ½ inch ID and 4 inches in length attached to the hose barbs (3). There will also be ⅛ inch ID vinyl tubings attached to the hose barbs (4) also 4 inches in length. In FIG. 2, is a 3D view of the device without the top cap on the manifold. In this view you can see how the manifold itself is just a hollow tube with the hose barbs attached. As in figure one, this image shows the main tube body, (1) with the bottom adaptor tube (5) which is 7/16 OD inches. This drawing also shows in 3D the hose barbs as shown in FIG. 1. There are 3 of the ½ inch hose barbs, (3) along with 2 of the ⅛ inch hose barbs (4).

### DETAILED DESCRIPTION OF THE INVENTION

The Dental Unit Flush Adaptor was designed to aid in the flushing of the water lines on the hand piece tubings on any dental delivery unit made by any manufacturer in the world. This manifold as I have designed it, will also allow the user to attach any Cavitron, or any other brand of sonic hygiene cleaning instruments to the tubings as well. All dental hand piece tubings in the United States and throughout the world are a standard of width that will fit into the ½ inch ID tubings that will go onto the hose barbs (3) in the drawings. The ⅛ inch ID tubings that will attach to the hose barbs (4) will be used to insert the tips of any brand/manufacturer of Air/Water syringes. The bottom tube of the manifold (5) is 7/16 inches OD. This is also a standard size throughout the entire dental industry for the straws that fit into the vacuum valves that exist in every dental operatory to provide suction during procedures. When my device is put into use, there will be hoses attached to the hose barbs (3) and (4) from the drawing. The bottom 7/16 inch OD tube (5) coming of the bottom of the manifold will be inserted into any vacuum valve that is the standard HVE size within the dental industry. Once this device is inserted into the HVE vacuum valve within the dental operatory, the vacuum valve itself will be opened. At this point the manifold tube itself (1) will have a constant vacuum pressure coming from the tubes attached to the hose barbs (3) and (4). With my manifold inserted into HVE vacuum valve, with the valve open and the hoses attached to the hose barbs, the operator of this device can then insert the end of the hand piece tubings from the dental unit itself into the open end of the tubings attached to the hose barbs (3). The next step will be to take both of the Air/Water syringes with the syringe tips attached to the Air/Water syringe itself and insert those syringe tips into the ⅛ inch ID tubings that are attached to the manifold (4). Once these connections are made, the operator of the device can use the “flush” button/toggle that is on all dental units to activate the water flow to the end of the hand piece tubing. This device will allow the operator to flush the water system using the vacuum system within the dental operatory. This device is also designed so that all the hand piece tubings and Air/Water syringes can be flushed at once.

1. The Dental Unit Flush Adaptor as I designed it, is intended to be a tool to aid all dentists and their respective office staffs in providing a much more efficient way to flush the water lines on any type of make/model of dental delivery unit anywhere in the world.

2. By using this device to flush the water lines, the user will no longer need to flush the lines one at a time into a bucket or a sink, now doing this routine maintenance will be much more time efficient, but will also be more effective since my device will allow the hand piece tubings and the Air/Water syringes to be vacuumed out.

3. This method provides a drastic increase in the effectiveness of just flushing the lines alone, and cuts down on the time spent performing this task since every piece on the dental delivery unit can be flushed at the same time, and flushed with greater pressure. This device simply makes doing this routine maintenance much easier than the method that has been used for years up until now.

4. There is also an additional benefit that will be provided by using the Dental Unit Flush Adaptor, which is helping the dental office drastically cut down the bio-film that grows inside the waterlines of all dental delivery units within the water lines.

5. The bio-film problem has been one of the biggest concerns and problems within the dental industry for many years. There are many products on the market from filters to tablets that help cut down on bio-film growth drastically but the most effective way to help prevent this problem is still the routine flushing of the water lines. All manufacturers of dental equipment recommend that the lines of these delivery units need to be flushed at least daily and along with that every manufacturer installs either a flush button or a toggle valve that will flush the hand piece tubings on their dental delivery units. This simple task is almost never followed by the majority of dental office staff in any office. As a dental equipment service technician for the last nine years, I have seen hundreds of problems in the dental delivery units caused by bio-film growth that could have been prevented with the regular flushing of the water lines recommended by the dental equipment manufacturers.

6. This is how my device will solve another very common and dangerous problem in the dental industry with helping to eliminate the bio-film growth in the hand piece tubings and the water lines that are connected to the Air/Water syringes. As I stated above, flushing the lines has always been very effective at purging out the bio-film as it grows, and it replaces the lines with fresh water. However, as bio-film starts to grow inside these tubings that are 1/16 inch ID in the dental delivery units, it first starts as tiny clumps, roughly the size of fine sand and these clumps are the viscosity of a raw oyster. If at this point these lines are not flushed, these bio-film clumps begin to grow larger and form larger clumps, and again these clumps feel and look like a raw oyster for comparison. Eventually if the lines are not flushed, these bio-film clumps will clog the water lines. I still have service calls at offices now where a hand piece tubing will not have water because of a bio-film clog.

7. My device along with providing an easier and more efficient way to flush the water lines, was initially designed to help eliminate the bio-film growing inside the water lines along with helping to dislodge clogs within the water line tubings on the delivery units. By designing a manifold that will join the hand piece tubings, Air/Water syringe tubings, and hygiene scaling hand piece tubings, to the vacuum system, the operator can actually vacuum out the water lines. By introducing the vacuum to this process, now you are not only flushing the water lines but you are performing this routine task with pressure. By increasing the water pressure flowing out through the tubing into the vacuum adaptor I have designed, the dramatic increase in the water pressure will clear out any bio-film growth that has started to form and this is much more effective at removing the bio-film growth than just the standard flushing of the water line alone. This method, by using my invention provides drastically better results in helping to clear out the bio-film.

8. Also, another collateral benefit that I have discovered during my field tests of my device, is that I have discovered that when hooking my device up to use to flush the water lines, I have had numerous instances during my testing where I have had a clogged waterline to a hand piece tubing or an Air/Water syringe where my device has actually been able to clear out clogs and return the water flow to the hand piece, Air/Water syringe or hygiene scaler hand piece. This device would be very valuable to all dental offices as many of these “bio-film clogs” would be able to be fixed in the office by either the dentist, the dental assistant or the hygienist.
